(19) United States
(12) Patent Application Publication
(10) Pub. No.: US 2026/0019837 A1
(43) Pub. Date: Jan. 15, 2026

(54) DATA COLLECTION FOR ARTIFICIAL INTELLIGENCE IN WIRELESS COMMUNICATIONS

(71) Applicant: Lenovo (Singapore) Pte. Ltd, Singapore (SG)

(72) Inventors: Vahid Pourahmadi, München (DE); Joachim Löhr, Wiesbaden (DE); Tapisha Soni, Munich (DE); Robin Rajan Thomas, Frankfurt (DE)

(73) Assignee: Lenovo (Singapore) Pte. Ltd, Singapore (SG)

(21) Appl. No.: 18/772,047

(22) Filed: Jul. 12, 2024

(51) Int. Cl. H04W 24/08; H04W 24/02; H04W 72/231

(52) U.S. Cl. CPC H04W 24/08; H04W 24/02; H04W 72/231

(57) ABSTRACT

Various aspects of the present disclosure relate to data collection for artificial intelligence in wireless communications. An apparatus, such as a UE, receives control information comprising a first field indicating a trigger event for a data collection process, where the trigger event is based at least in part on one or more of a data sample novelty measure, a change in a configuration parameter of a node, a change in a condition of a node, a model performance metric, or model monitoring output. The apparatus triggers, based at least in part on an occurrence of the trigger event, a data collection process to generate a reporting set from a set of measured samples, and processes the reporting set based at least in part on the control information including to one or more of report the reporting set to a different node or log the reporting set to generate a logged reporting set.

### TECHNICAL FIELD

The present disclosure relates to wireless communications, and more specifically to data collection (e.g., aggregation, communication, transmittal, retrieval) for artificial intelligence (AI) in wireless communications.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The wireless communications system may support wireless communications, and may include one or more devices, such as UEs, base stations (e.g., gNBs), network entities, satellites, and/or network equipment (NE), among other devices, that transmit and/or receive signaling.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may include a UE for wireless communication to receive (e.g., obtain, request) control information including a first field indicating a trigger event for a data collection process, wherein the trigger event is based at least in part on one or more of a data sample novelty measure, a change in a configuration parameter of a node, a change in a condition of a node, a model performance metric, or model monitoring output; trigger (e.g., initiate, cause), based at least in part on an occurrence of the trigger event, a data collection process to generate a reporting set from a set of measured samples; and process (e.g., generate, compute) the reporting set based at least in part on the control information including to one or more of report (e.g., transmit, communicate) the reporting set to a different node or log (e.g., store) the reporting set to generate a logged reporting set.

In some implementations of the method and apparatuses for a UE described herein, the control information includes downlink control information (DCI); the different node includes one of a first network equipment from which the control information is received, or a second network equipment different than the first network equipment, and wherein the at least one processor is configured to cause the UE to transmit, based at least in part a request or a reporting event, the reporting set to one or more of the first network equipment or the second network equipment; the set of measured samples includes a set of channel data representations during a first time-frequency-space region; the control information includes one or more other fields including at least one of one or more purposes of the data collection process, an indication that the UE is to maintain the reporting set after reporting the reporting set, an indication specifying how to determine the data sample novelty measure for one or more data samples, a threshold number of data samples to be reported, a duration over which to report the reporting set, a duration over which to log the reporting set, or a set of additional information for determination of the data sample novelty measure; the set of additional information includes a set of parameters representing a model based on a neural network; the control information includes one or more other fields including one or more of values or conditions for UE configuration or UE conditions for which the UE is to monitor UE change, a duration over which to report the reporting set after the trigger event, a duration over which to log the reporting set after the trigger event, how many data samples to report as part of the reporting set, or how many data samples to log as part of the reporting set.

In some implementations of the method and apparatuses for a UE described herein, the control information includes one or more other fields including one or more of one or more purposes of the data collection process, a metric value to trigger the trigger event, a threshold value to trigger the trigger event, a duration over which to report the reporting set after the trigger event, a duration over which to log the reporting set after the trigger event, how many data samples to report as part of the reporting set, or how many data samples to log as part of the reporting set; the at least one processor is configured to cause the UE to generate the reporting set based on a configuration including one or more fields including at least one of one or more purposes of the data collection process, an indication that the UE is to maintain the reporting set after reporting the reporting set, an indication specifying how to determine the data sample novelty measure for one or more data samples, a threshold number of data samples to be reported, a duration over which to report the reporting set, a duration over which to log the reporting set, or a set of additional information for determination of the data sample novelty measure; the configuration is received as part of the control information; the at least one processor is configured to cause the UE to generate the reporting set including at least one of a subset of the set of measured samples or a sample subset generated based at least in part on a subset of the set of measured samples; the reporting set further includes at least one of one or more quality values for measurements used to generate the reporting set, one or more confidence values for measurements used to generate the reporting set, a rate of occurrence for one or more data samples of the reporting set, or one or more Conditions under which the measurements used to generate the reporting set were measured; the control information includes configuration information for multiple data collection processes.

Some implementations of the method and apparatuses for a described herein may further include a processor for wireless communication to receive control information including a first field indicating a trigger event for a data collection process, wherein the trigger event is based at least in part on one or more of a data sample novelty measure, a change in a configuration parameter of a node, a change in a condition of a node, a model performance metric, or model monitoring output; trigger, based at least in part on an occurrence of the trigger event, a data collection process at a UE to generate a reporting set from a set of measured samples; and process the reporting set based at least in part on the control information including to one or more of report the reporting set to a different node or log the reporting set to generate a logged reporting set.

Some implementations of the method and apparatuses described herein may further include a method performed by a UE, the method including receiving control information including a first field indicating a trigger event for a data collection process, wherein the trigger event is based at least in part on one or more of a data sample novelty measure, a change in a configuration parameter of a node, a change in a condition of a node, a model performance metric, or model monitoring output; triggering, based at least in part on an occurrence of the trigger event, a data collection process to generate a reporting set from a set of measured samples; and processing the reporting set based at least in part on the control information including to one or more of report the reporting set to a different node or log the reporting set to generate a logged reporting set.

In some implementations of the method and apparatuses for a UE described herein, the control information includes DCI; the different node includes one of a first network equipment from which the control information is received, or a second network equipment different than the first network equipment, and wherein the method further includes transmitting, based at least in part a request or a reporting event, the reporting set to one or more of the first network equipment or the second network equipment; the set of measured samples includes a set of channel data representations during a first time-frequency-space region; the control information includes one or more other fields including at least one of one or more purposes of the data collection process, an indication that the UE is to maintain the reporting set after reporting the reporting set, an indication specifying how to determine the data sample novelty measure for one or more data samples, a threshold number of data samples to be reported, a duration over which to report the reporting set, a duration over which to log the reporting set, or a set of additional information for determination of the data sample novelty measure; the set of additional information includes a set of parameters representing a model based on a neural network; the control information includes one or more other fields including one or more of values or conditions for UE configuration or UE conditions for which the UE is to monitor UE change, a duration over which to report the reporting set after the trigger event, a duration over which to log the reporting set after the trigger event, how many data samples to report as part of the reporting set, or how many data samples to log as part of the reporting set.

In some implementations of the method and apparatuses for a UE described herein, the control information includes one or more other fields including one or more of one or more purposes of the data collection process, a metric value to trigger the trigger event, a threshold value to trigger the trigger event, a duration over which to report the reporting set after the trigger event, a duration over which to log the reporting set after the trigger event, how many data samples to report as part of the reporting set, or how many data samples to log as part of the reporting set; the method further includes generating the reporting set based on a configuration including one or more fields including at least one of one or more purposes of the data collection process, an indication that the UE is to maintain the reporting set after reporting the reporting set, an indication specifying how to determine the data sample novelty measure for one or more data samples, a threshold number of data samples to be reported, a duration over which to report the reporting set, a duration over which to log the reporting set, or a set of additional information for determination of the data sample novelty measure; receiving the configuration as part of the control information; generating the reporting set including at least one of a subset of the set of measured samples or a sample subset generated based at least in part on a subset of the set of measured samples; the reporting set further includes at least one of one or more quality values for measurements used to generate the reporting set, one or more confidence values for measurements used to generate the reporting set, a rate of occurrence for one or more data samples of the reporting set, or one or more Conditions under which the measurements used to generate the reporting set were measured; the control information includes configuration information for multiple data collection processes.

Some implementations of the method and apparatuses described herein may further include a NE for wireless communication to transmit (e.g., communicate, send), to a UE, control information including a first field indicating a trigger event for a data collection process, wherein the trigger event is based at least in part on one or more of a data sample novelty measure, a change in a configuration parameter of a node, a change in a condition of a node, a model performance metric, or model monitoring output; and receive (e.g., obtain, request) a report including a reporting set of data samples generated based at least in part on the control information.

In some implementations of the method and apparatuses for a NE described herein, the at least one processor is configured to cause the network equipment to transmit the control information via DCI; the control information includes one or more other fields including at least one of one or more purposes of the data collection process, an indication that the UE is to maintain the reporting set after reporting the reporting set, an indication specifying how to determine the data sample novelty measure for one or more data samples, a threshold number of data samples to be reported, a duration over which to report the reporting set, a duration over which to log the reporting set, or a set of additional information for determination of the data sample novelty measure; the set of additional information includes a set of parameters representing a model based on a neural network; the control information includes one or more other fields including one or more of values or conditions for UE configuration or UE conditions for which the UE is to monitor UE change, a duration over which to report the reporting set after the trigger event, a duration over which to log the reporting set after the trigger event, how many data samples to report as part of the reporting set, or how many data samples to log as part of the reporting set.

Some implementations of the method and apparatuses described herein may further include a method performed by a NE, the method including transmitting, to a UE, control information including a first field indicating a trigger event for a data collection process, wherein the trigger event is based at least in part on one or more of a data sample novelty measure, a change in a configuration parameter of a node, a change in a condition of a node, a model performance metric, or model monitoring output; and receiving a report including a reporting set of data samples generated based at least in part on the control information.

In some implementations of the method and apparatuses for a NE described herein, the method further comprising transmitting the control information via DCI; the control information includes one or more other fields including at least one of one or more purposes of the data collection process, an indication that the UE is to maintain the reporting set after reporting the reporting set, an indication specifying how to determine the data sample novelty measure for one or more data samples, a threshold number of data samples to be reported, a duration over which to report the reporting set, a duration over which to log the reporting set, or a set of additional information for determination of the data sample novelty measure; the set of additional information includes a set of parameters representing a model based on a neural network; the control information includes one or more other fields including one or more of values or conditions for UE configuration or UE conditions for which the UE is to monitor UE change, a duration over which to report the reporting set after the trigger event, a duration over which to log the reporting set after the trigger event, how many data samples to report as part of the reporting set, or how many data samples to log as part of the reporting set.

### BRIEF DESCRIPTION OF THE DRAWINGS

FIG. 1 illustrates an example of a wireless communications system in accordance with aspects of the present disclosure.

FIG. 2 illustrates an example AI framework 200.

FIG. 3 illustrates an example of a UE 300 in accordance with aspects of the present disclosure.

FIG. 4 illustrates an example of a processor 400 in accordance with aspects of the present disclosure.

FIG. 5 illustrates an example of a NE 500 in accordance with aspects of the present disclosure.

FIG. 6 illustrates a flowchart of a method 600 in accordance with aspects of the present disclosure.

FIG. 7 illustrates a flowchart of a method 700 in accordance with aspects of the present disclosure.

### DETAILED DESCRIPTION

In a wireless communications system, a UE and a NE (e.g., a base station, gNB) may support wireless communication (e.g., reception and/or transmission of wireless communication) using time-frequency resources. Further, wireless communications systems can utilize artificial intelligence (AI) and machine learning (ML) (AI/ML, which may be hereinafter referred to as “AI”) for a variety of different purposes, such as for network operation, network optimization, automated processing (e.g., self-driving cars in vehicle to everything (V2X) scenarios), network planning, security information and event management (SIEM)), etc. AI can leverage AI models (referred to herein as “models”) which represent programs and/or algorithms trained on a set of data to provide outputs, such as to recognize patterns, make decisions, generate content, etc. AI models, for instance, can apply different algorithms to data inputs to provide output for performing different tasks.

AI in wireless communications systems can involve processes such as model training, model testing, and model inference to enable AI models to perform different tasks pertaining to wireless communications. Further, multiple nodes (e.g., UEs and NEs) can be involved in AI functionality that can exchange data and can each perform different AI processing to perform AI tasks. AI models can be trained for different datasets, scenarios, and configurations, and multiple models may be implemented for individual AI functionality supported by nodes. For instance, a model for an AI functionality supported by a particular node (e.g., a UE) may be trained with a dataset subject to conditions of a first node (e.g., UE and/or gNB) and conditions of a second node (e.g., a different UE and/or gNB).

Several schemes have been proposed to use AI models for wireless communications to reduce overhead, improve performance, and reduce latency of a communication link. For example, AI/ML models can be used for channel state information (CSI) feedback compression, modulation/demodulation, scheduling, interference management, positioning, etc. The design and optimization of AI procedures and AI models can be use case dependent. Further, training, updating, fine-tuning, and/or monitoring of models can be based on data collected from an environment.

Minimization of Drive Tests (MDT) is a feature introduced by the 3rd Generation Partnership Project (3GPP) for data collection from the environment. The aim of this feature is to enhance the performance of networks and improve user experience by optimizing the process of network measurement and data collection. The goal is to minimize the reliance on drive tests, which are traditionally used to collect data for network optimization and troubleshooting. Drive tests involve sending personnel to physically drive around in vehicles equipped with measurement equipment to gather network performance data, which can be costly and time-consuming.

In an MDT framework, instead of a designated test equipment, a UE can be configured to measure various network performance indicators such as signal strength, quality, and coverage. This data can then be used by network operators to assess and improve network performance. MDT is designed to collect data both in real-time and over long periods, with the measurements being triggered by specific network events or collected periodically during regular device usage. This passive and active data collection method enables operators to gather a comprehensive understanding of network conditions without deploying extensive field-testing resources. Steps of an MDT procedure can involve UEs being configured by the network to collect specific measurement data, which can include parameters like reference signal received power (RSRP), reference signal received quality (RSRQ), and other network performance metrics. The UE can either report the data immediately when certain predefined conditions are met or can log the data for transmission at a later time, e.g., when transmission may have a reduced impact on user experience. This flexible data collection method ensures continuous monitoring of network performance, allowing operators to quickly identify and resolve issues, optimize resource allocation, and enhance overall service quality. MDT leverages the widespread availability of UEs to provide a cost-effective and efficient way to maintain and improve mobile network performance.

Aspects of the present disclosure are described in the context of a wireless communications system, and include implementations that provide for defining events and procedures that can be used for data collection (not limited to MDT use cases) while maintaining compatibility with at least some current event data collection mechanisms defined in MDT frameworks.

For instance, implementations described in the present disclosure include improvements to data collection for AI models, e.g., improvements to MDT frameworks. For instance, implementations provide for efficient data collection including channel reporting and triggering event based on factors such as novelty of data, triggering events, network configuration, network additional conditions, UE additional conditions, and data collection triggering based on model performance. Further, data reporting aspects are described such as criteria for reporting data, reporting of additional information, and sample digest reporting. Implementations also provide for configuring multiple logging configurations.

By utilizing the described techniques, consistent utilization of AI models and/or functionality across a wireless communication network (e.g., at UEs and/or NEs) can be realized, which can increase signaling accuracy, reduce signaling errors, and reduce signaling overhead, among other benefits.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

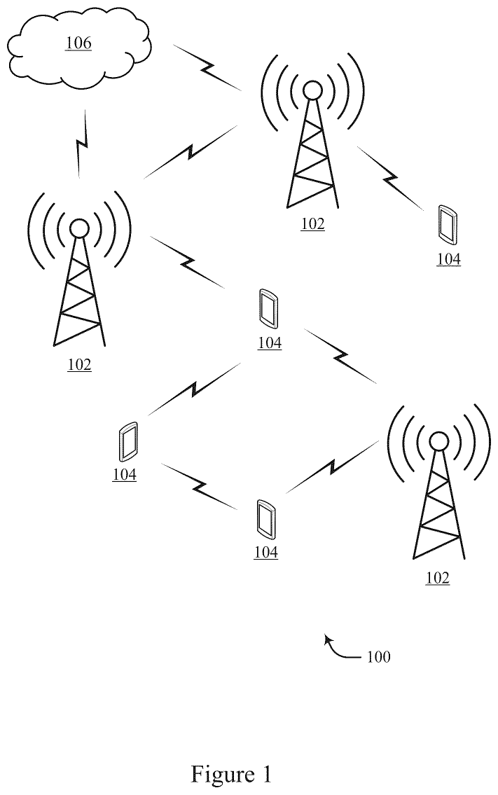

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=⁴) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a UE 104 can receive from a NE 102 control information comprising a first field indicating a trigger event for a data collection process, wherein the trigger event is based at least in part on one or more of a data sample novelty measure, a change in a configuration parameter of a node, a change in a condition of a node, a model performance metric, or model monitoring output. In an example a trigger event can include receiving a command to perform a data sample novelty measurement. As another example the trigger event can include determining or identifying a change in a configuration parameter, such as a defined configuration parameter for data collection. As another example the trigger event can include determining or identifying a change in a condition of a node, such as a UE position change, a NE traffic change, a connectivity change of a UE and/or NE, etc.

The UE 104 triggers, based at least in part on an occurrence of the trigger event, a data collection process to generate a reporting set from a set of measured samples, and processes the reporting set based at least in part on the control information including to one or more of report the reporting set to a different node or log the reporting set to generate a logged reporting set.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

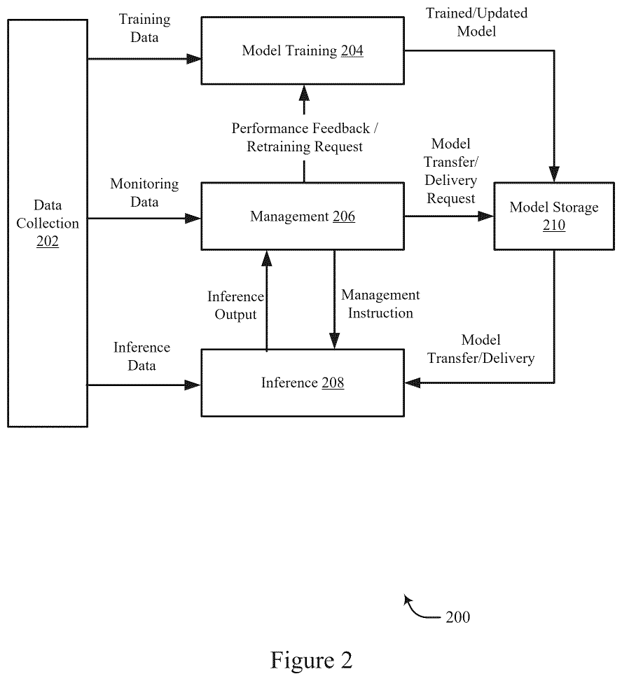

FIG. 2 illustrates an example AI framework 200. The AI framework 200 includes data collection functions 202, model training functions 204, management functions 206, inference functions 208, and model storage functions 210. The data collection function 202 can provide input data to the model training functions 204, management functions 206, and inference functions 208. The training data can represent data used as input for the model training function 204. The monitoring data can represent data used as input for the management functions 206, e.g., for AI models and/or AI functionalities.

In the AI framework 200 inference data can be used as input for the inference functions 208. Further, the model training functions 204 can perform model training, validation, and testing which may generate model performance metrics that can be used as part of the model testing procedure. The model training functions 204 can also perform data preparation (e.g., data pre-processing and cleaning, formatting, and transformation) based on training data delivered by the data collection function 202. The management function 206 can oversee the operation (e.g., selection, (de)activation, switching, fallback, etc.) and monitoring (e.g., performance) of models and/or AI functionalities. The management function 206 can also make decisions to ensure the proper inference operation based on data received from the data collection function 202 and the inference function 208. Management instruction can represent information for input to manage the inference function 208, such as information for selection, (de)activation, switching of models and/or AI-based functionalities, fallback to non-AI/ML operation (e.g., not relying on inference processes), etc. A model transfer/delivery request can be used to request model(s) to the model storage function 210.

Further to the AI framework 200 performance feedback/retraining request can represent information for input for the model training function 204, e.g., for model (re)training and/or model updating purposes. The inference function 208 can provide outputs from processes of applying AI/ML models and/or AI/ML functionalities using the data that is provided by the data collection function 202 (e.g., inference data) as input. The inference function 208 can also perform data preparation (e.g., data pre-processing and cleaning, data formatting, data transformation, etc.) based on inference data delivered by the data collection function 202. Inference output can represent data used by the management function 206 to monitor the performance of models and/or AI/ML functionalities. The model storage functions 210 can store trained models and/or updated models that can be used to perform the inference functions 208.

Two types of MDT have been discussed, immediate MDT and logged MDT. Immediate MDT focuses on real-time data collection from UE configured by the network or triggered by specific events or conditions and is applicable of UEs in RRC_CONNECTED state. This method can involve the UE instantly reporting various network measurements to the network whenever predefined triggers, such as thresholds for signal strength or quality, are met. The data reported includes critical performance indicators such as RSRP, Reference Signal Received Quality (RSRQ), and other relevant metrics that provide a snapshot of the network's current state. As immediate MDT is able to provide real-time network data, it can be particularly useful in scenarios that demand quick resolution, such as during network outages or when optimizing handovers in dense urban environments. Immediate MDT thus enhances the capacity for proactive network management, contributing to improved user experience and more robust network operations.

Logged MDT is a feature designed to enhance network performance monitoring by allowing a UE to collect and log network performance data over time. Unlike immediate MDT, which reports data in real-time, logged MDT enables UEs to record various measurements during normal usage (applicable to RRC_INACTIVE and RRC_IDLE states) and the report them later (by switching to RRC_CONNECTED state), typically when the device is idle or connected to a non-cellular network. This approach provides a rich dataset without imposing significant overhead on the network or impacting user experience. The network can configure the UE for Logged MDT by specifying the parameters to be measured, the conditions under which measurements should be taken, and the logging duration. The collected data includes critical network performance metrics such as signal strength (RSRP), signal quality (RSRQ), throughput, and location information, which can be based on GPS or cell identifier, identity (ID). The data is stored in the UE's memory and periodically updated as the UE moves through different areas and experiences varied network conditions. Once the logging period is complete or when predefined conditions for data reporting are met, the UE sends the logged data back to the network, usually when it has sufficient connectivity without impacting the primary service.

In each of these schemes, there are a) data collection and b) reporting steps. The MDT configuration message is important to the configuration process and contains detailed instructions on: (1) What to measure: The specific parameters the UE needs to monitor (e.g., signal strength, quality, handover events); (2) When to measure and report: The timing and conditions for measurement (periodically, event-triggered, or based on location); and (3) How/when to report: The format, frequency, and destination for sending the collected data back to the network.

3GPP uses information element (IE) MeasConfig which is part of RRCReconfiguration or RRCResume message to configure MDT which further consist of: (i) The IE MeasIdToAddModList and measObjectToRemoveList which contain a list of MeasObjectToAddMod (measurement identities) to add or modify where each measurement identities composed of the association between a measurement object and a reporting configuration. The measurement object, MeasObject, primarily defines what to measure; (ii) The IE reportConfigToAddModList and reportConfigToRemoveList which specifies ReportConfigToAddMod element which defines a specific reporting configuration, e.g., the Reporting criterion, reference signal (RS) type, and Reporting format.

The reporting type can be of event triggered reporting, periodic reporting, cell global identity (CGI) reporting or space-frequency time diversity (SFTD) reporting. Also, for logged MDT, the UE can be configured to start logging using LoggedMeasurementConfiguration message. The summary of parameters/methods defined in MDT for the reporting/logging is as follows:

Threshold-Based: The network configures thresholds for different CSI-RS based metrics using which the UE decide when to report/log the data. (i) RSRP (Reference Signal Received Power): The power of the CSI-RS received by the UE; (ii) RSRQ (Reference Signal Received Quality): The quality of the CSI-RS received by the UE, taking into account both signal strength and interference; (iii) SINR (Signal-to-Interference-plus-Noise Ratio): The ratio of the desired signal power to the interfering and noise power in the CSI-RS.

Time-Based Reporting Criteria: (i) Logging Interval: Specifies the interval at which the UE logs the measurement data, typically in ms or seconds (e.g., every 120 ms); (ii) Duration: Total duration for which the reporting is active (e.g., over a period of 10 minutes).

Location-Based Reporting Criteria: (i) Area-based Reporting: Data collection can be triggered when the UE enters or exits specific cell IDs or area defined by areaConfiguration; (ii) Spatial Relation Based Reporting (SFTD: Leverages the concept of “spatial relations” between the UE and reference points, which can be beams (defined by beam reference signals) or cell identities. Reports can be triggered based on trigger events such as: Entering or leaving a specific beam (SFTD-enter, SFTD-leave); distance to a beam exceeding a certain threshold (SFTD-distance); Distance to a cell exceeding a certain threshold, signal quality falling below a signal quality threshold, etc.

Event Triggered Measurements and Reporting. These events are predefined conditions such as changes in signal strength or quality that trigger data collection. The UE starts gathering data when these events occur: Event A1: Serving cell becomes better than a threshold; Event A2: Serving cell becomes worse than a threshold; Event A3: Neighbour becomes amount of offset better than PCell/PSCell; Event A4: A neighbour cell becomes better than a threshold; Event A5: PCell/PSCell becomes worse than absolute threshold1 AND Neighbour/SCell becomes better than another absolute threshold2; Event A6: Neighbour becomes amount of offset better than SCell; Event B1: Inter-RAT neighbour cell becomes better than a threshold; Event B2: PCell becomes worse than absolute threshold1 AND Neighbour becomes better than another absolute threshold2.

For an event-based reporting triggerConfig defines the conditions that trigger a measurement report which contains:
triggerType: Specifies the type of trigger: event: Report when a specific event occurs (e.g., crossing signal strength threshold, entering a new cell); periodic: Report at regular intervals; onDemand: Report upon explicit request from the network.
eventId (for event triggers): The specific event ID.
triggerQuantity (for event triggers): The measurement quantity to be monitored for the event (e.g., rsrp, rsrq, sinr).
Thresholds and offsets: The threshold values and offset used for triggering the report.
hysteresis: A margin to prevent frequent triggering near the threshold.
timeToTrigger (for event triggers): The time duration to wait after the event condition is met before triggering the report.
reportInterval (for periodic triggers): The time interval between reports.
reportAmount (for periodic triggers): The number of reports to send after a trigger.
reportOnLeave: whether or not the UE is to initiate the reporting procedure when the leaving condition.

The measurement and reporting mechanism for MDT are mainly developed for the MDT use cases. To reuse the MDT framework for data collection for A1 model training, monitoring, or model update, the framework may need to be optimized as discussed in the present disclosure.

Aspects of the present disclosure include solutions for optimization of data collection for AI scenarios.

Implementations include triggering events based on data novelty. An example event for MDT is to start reporting or logging of the data if the data has high probability of being useful for the intended AI/ML task. More specifically, having access to more samples potentially can be beneficial when a model is trained, updated, and/or monitored. However, due to the overhead associated with data collection, it is desirable to prioritize collection of samples (measurements) that are more likely to improve the performance of the trained/updated model or better determine the accuracy of the model.

These samples can be identified by observing how much new information that a sample can add to the training/updating/monitoring dataset which already includes some samples. For example, if a dataset already has many samples of the same form (e.g., providing similar statistical information), addition of another sample of the same form (statistics) may be less beneficial than addition of a sample which represents another form (statistics) of the data. Based on such scenarios, a new triggering event is described which starts reporting/logging when the UE has samples which may be more useful/important for model training/updating/monitoring

Some messages/fields/parameters that can be used in event-based signaling are discussed below. For instance, a message is provided for configuring a UE to use a triggering event using which the UE can start reporting/logging of data samples of measurement data based on an importance/novelty measure. A novelty measure, for instance, represents a measured variation between a data sample value and an average value of a group of other data samples. Examples of a novelty measure include a root mean square (RMS) comparison, a value variance, a comparison to a novelty value threshold, etc. For instance, a particular data samples may be indicated as being novel is a value of the data sample exceeds a threshold value from an average sample value of a group of data samples. As one implementation, the UE may be configured using a message as part of a radio resource control (RRC) message or inside of the EventTriggerConfig for example new event type (eventID).

As another example a message is provided for notifying the UE of the purpose of data collection, e.g., if the collected data is for model monitoring, for initial training of a model, for updating of a model, etc. The novelty/importance of a data sample may be based on a purpose of the data sample and may change the mechanism(s) that are used to determine the importance of data samples.

As another example a message is provided for configuring a UE to use data that it has previously collected to determine the importance/novelty of a new sample. For instance, in response to receiving this message, the UE may determine to not remove samples which are already reported, may keep some statistics related to samples, and/or may generate a model to assist the UE to determine the similarity of the past samples and the new samples.

As another example a message is provided for configuring a UE to determine how to determine the importance/novelty of a sample. In one example importance/novelty of a new sample can be determined by computing the correlation between the new sample and a set of previous samples. Importance/novelty of a sample can be implemented via a priority indication which may be explicit or implicit. For example, an explicit priority may be associated with value ‘1’ indicating a sample with higher importance or high priority statistical information while a higher value may indicate a priority less than the value ‘1’. In this case the explicit priority may be signaled along with the desired samples to be collected, e.g., for cases where multiple samples to be provided which may involve sample ordering. In another implementation, the ordering of sample importance may be implicit in the configuration, e.g., based on descending order of priority whereby the samples that appear on the top of the list are highest priority and samples going down the list are of lower priority to be collected for an event that is triggered. Another example may make use of ascending order of priority of importance regarding samples to be collected.

In some implementations the importance level can be logged/reported and in some cases a UE may use the importance level to report/log the sample but not keep or send the importance value itself. In some implementations instead of a value for importance, the UE may have “M” categories (groups) of samples. The UE can categorize the samples based on their importance level to each of the groups.

As another example a message is provided for configuring a UE with at least one threshold using which the UE can determine if it should trigger an event. For example, if the importance of the samples is more than the threshold, the UE can start the reporting/logging. As another example a message is provided for configuring a UE with a maximum and/or minimum number samples the UE is to transmit. Based on this number(s) and the importance value, the UE may determine up to which threshold the UE is to report/log the samples. As another example a message is provided for configuring a UE to determine which sample categories (e.g., up to which sample category) samples should be reported/logged.

As another example a message is provided for configuring a UE to determine how many samples to the UE is to observe with importance higher than the threshold before triggering the event. The threshold number of samples may be presented by a variable or value N, with an associated value range configured by the network and signaled to the UE.

As another example a message is provided for configuring a UE with at least one threshold using which the UE can determine the UE is to stop the reporting/logging of samples. For example, if the importance of the samples becomes less than a threshold, the UE can stop reporting/logging samples. In an example the threshold may be associated with a hysteresis value + or − the threshold to avoid frequent or unnecessary start/stopping of reporting of logging samples.

As another example a message is provided for configuring a UE with a threshold of how many samples the UE is to detect with importance less than the threshold before triggering the event. As another example a message is provided for configuring a UE with a time duration that the UE is to continue reporting/logging after a reporting/logging event is triggered. As another example a message is provided for configuring a UE with how many samples the UE is to continue reporting/logging after an event has been triggered. This message can indicate the number of all samples or a number of samples with high importance which are collected (based on a criteria) after the event is triggered.

As another example a message is provided for the network and/or the training node to send the UE to assist the UE to determine which samples are of higher importance. Examples of such samples include a set of samples from (or similar to) the training dataset. The UE can compare the new samples with this sample set to determine the level of novelty. In at least one implementations the UE is configured to use this sample set for novelty level when the number of UE reported/logged samples are lower than a threshold. In at least one implementation, the UE is configured to use this sample set for novelty level along with the samples the UE has previously logged/reported.

In implementations a set of parameters can be provided representing the statistics of the data already collected. For example, if a UE observes samples with different statistics the samples can be of high importance. In an example the sample(s) could be the one or a few means and variances for different clusters of the collected samples.

Implementations can also provide information regarding an algorithm/model (e.g., neural network (NN) model) using which the UE can determine to the importance of the samples. In one example the information can indicate that the network indicates an outlier detection model and sends the model to the UE the implement the model to determine if a sample is important or not. For instance, a sample which is an outlier may have a higher importance and a number of such samples to determine whether a sample represents noise. Information regarding the model can directly identify the model and its parameters, and/or an ID can be provided with which the UE can determine/retrieve the model, e.g., from another node.

In an example the NN model can be related to the model (or the actual model) that has been trained (or that is currently used for inference), and the model can be used to determine the importance of the sample. For example, data is being collected for model update, a particular measured sample can be tested by comparing the output of the NN model for that sample and the expected output. If the output and the expected output are within a threshold difference, the sample may be indicated as low importance since the model utilizes knowledge of the sample. If the output and the expected output are outside of a threshold difference or the confidence of the output is low, the sample can be indicated as a sample with high importance. For example, data is being collected for model monitoring, the importance of a particular measured sample can be evaluated using the confidence of the output model for that sample. Implementations can also utilize a model to show the complexity of the input data, e.g., more complex samples can have a higher importance.

In implementations the described information can be updated in a periodic, aperiodic, or event base manner. Information update can assist the network/training node to reflect the most recent statistics of the data which can enable a better determination of the importance values. The use of statistics in the above discussion can refer to various descriptive, quantitative, and inferential metrics that can be used to summarize and interpret the samples collected and be used to analyze the dataset comprising the samples. These can include but not limited to mean (average), measures of dispersion including standard deviation, measures of shape including skewness or kurtosis, measures of position including percentiles, quartiles and so forth. Other statistical information may include probability density function/distributions (PDFs), cumulative density functions/distributions (CDFs).

Implementations also provide for triggering of MDT where specific conditions change, e.g., UE and/or network additional conditions. A model training node may determine that the node is to obtain samples for a network configuration, a network condition, and/or a UE condition. For example, the training node is to train a model for beam management Case1 where the network implements an associated ID, e.g., α₁ and for network condition equal to c₁. The training node may have a dataset for other settings. In another example of a network additional condition in the case of the positioning may be a synchronization error (e.g., real transmit time difference), the network may utilize a sample when the synchronization error is above a certain error value to complete the statistics of the network data set.

In examples a triggering event can be defined based on a set of network configuration, UE side additional condition, and/or network side additional condition. For instance, when the UE determines that the current samples are under this state, the UE can initiate reporting/logging. In an additional or alternative implementation, the UE can be configured to transmit a certain number of samples or for a certain duration as soon as it detects a change in at least one of a network configuration, UE-side additional condition, or network-side additional condition.

Examples of messages/fields/parameters that can be used in this signaling are: A message configuring the UE to use a triggering event to start reporting/logging of data associated for a specific network configuration. UE-side additional condition, or network-side additional condition; a message notifying the UE of the purpose of the data collection or particular AI/ML life cycle management procedure, e.g., if the collected data is for model monitoring, for initial training of a model, or for updating of a model; a message that configures the values/conditions for one or more network configurations. UE-side additional conditions, or network-side additional conditions for which the UE is to start reporting/logging; a message that configures the set of one or more of the network configuration. UE-side additional condition, or network-side additional condition that the UE is to monitor and if these conditions are modified, the UE is to start reporting/logging; a message that configures the UE with a value specifying how long the UE is to continue reporting/logging after it has triggered; a message that configures the UE with how many samples the LIE is to continue reporting/logging after it has been triggered. An associated field can indicate the number of all samples or only the number of samples with high importance which are collected (e.g., based on a criteria) after the event is triggered.

Implementations also provide for data collection triggering based on model performance metrics and/or model monitoring output. In an example an indication that current measurements can represent valuable samples (e.g., samples above a threshold importance) are when a determination is made that a model is not performing within an acceptable range. For example, consider that there exists a monitoring scheme which monitors the performance of the model. For some scenarios (e.g., if the statistics of the input data changes) the model might be not able to perform correctly which can be detected by the model monitoring scheme. Reporting/logging of such samples then can be to detect a problem with the model and retrain the model to support these samples. In additional or alternative implementations to a model monitoring scheme, the report/logging could be initiated directly based on the model output and/or the confidence of the model output. The model monitoring scheme can also have different implementations based on different metrics, e.g., intermediate key performance indicators (KPI), squared generalized cosine similarity (SGCS), throughput, block error rate (BLER), positioning accuracy, etc.

Some messages/fields/parameters that could potentially be used in associated signaling include: A message configuring the UE to use a triggering event using which the UE starts reporting/logging of data based the performance of the model, confidence of the output, or the output of model monitoring scheme; a message notifying the UE which metric is to be used for triggering of the event, e.g., model output, intermediate KPI, throughput, results of model monitoring, model output confidence; a message that configures the UE with at least one threshold using which the UE can determine if it is to trigger the event. For example, if the model output confidence is less that the threshold, start the reporting/logging; a message that configures the UE with how many samples the UE is to detect with importance higher than the threshold before triggering the event; a message that configures the UE with a time duration over which to continue reporting/logging after data collection has triggered: a message that configures the UE with how many samples it should continue reporting/logging after it has been triggered. An associated field can indicate the number of all samples or only the number of samples with high importance which are collected (e.g., based on a criteria) after the event is triggered.

Implementations also provide for selected sample reporting. In the discussion above the notion is discussed of starting report/logging of samples when the samples may be more important for a task of model initial training/updating/monitoring. In the following discussion this notion is extended. For instance, assume that the MDT has started reporting/logging of the data. Some MDT implementations can report/log all samples that it measures until another condition satisfied to stop data collection. In implementations during sample reporting/logging, the importance/novelty of samples are monitored and the UE can report/log samples with importance/novelty that exceeds a threshold value. This can reduce the signaling overhead of reporting samples which are of low importance, e.g., below the threshold value.

In implementations messages/fields/parameters that can be used in such signaling are similar to those discussed above. One difference is that these messages/fields/parameters are not configured to be included for configuration of a particular even-triggering mechanism only. Instead, these messages/fields/parameters can be used as parameters for measurement or reporting configuration, for example inside of MeasObjec message or ReportConfig message, regardless of how the MDT reporting/logging procedure has been initiated.

Examples of such messages/fields/parameters include: A message configuring the UE to use selected sample reporting/logging of data based on the samples' importance/novelty measures.

A further example includes a message notifying the UE of the purpose of the data collection, e.g., if the collected data is for model monitoring, for initial training of a model, for updating of a model, etc. A novelty/importance of a sample may be based on a purpose for the sample and the novelty/importance may change the mechanism that are used to determine the importance of samples.

A further example includes a message that configures the UE with how to determine the importance/novelty of the new sample. One example scheme is to compute a correlation between a new sample and a previous samples.

A further example includes a message that configures the UE to use the data the UE has previously collected to determine the importance/novelty of the new sample. For instance, receiving such a message, the UE may determine not to remove samples which are already reported, may maintain some statistics related to such samples, and/or may generate a model to assist the UE to determine the similarity of previous samples and the new samples.

A further example includes a message that configures the UE with at least one threshold using which the UE can determine if the UE is to include the sample in the report/log. For example, if the correlation of the sample with the previous samples is less than the threshold, include it in the report/log. A further example includes a message that configures the UE with maximum and/or minimum number samples the UE is to transmit. Based on this number(s) and the importance value, the UE can determine up to what threshold the UE is to report/log the samples.

A further example includes a message that configures the UE to determine which sample categories (e.g., up to which sample category) are to be reported/logged. A further example includes a message that configures the UE with a time duration to continue reporting/logging. A further example includes a message that configures the UE with how many samples the UE is to continue reporting/logging. This field can indicate a number of all samples or a number of samples with high importance which are collected (e.g., based on a criteria).

A further example includes a message that the network/training node can send the UE to assist the UE to determine which are to be collected/maintained. Examples information in such a message can include a set of samples from or similar to the training dataset. The UE can compare the new samples with this samples to determine the level of novelty. A further example of information in such a message can include a set of parameters representing the statistics of the data already collected. For example, if a UE observes samples with different statistics the samples may be indicated to be of high importance. An example can be the one or a few mean and variance for different clusters of the collected samples.

A further example of information in such a message is information regarding an algorithm/model (e.g., a NN model) using which the UE can determine to the importance of the samples. An example can be that the network designs an outlier detection model and sends the model to the UE to enable the LIE to determine whether a sample exceeds a threshold importance value, e.g., a sample which is an outlier may have a higher importance. The information regarding the model can be the model and its parameters and/or an ID using which the UE can determine/retrieve the model, for example from another node. In another example the NN model could be related to the model (or the actual model) that has been trained or that is currently used for inference, and this model can be used to determine the importance of the sample.

For example, if data is being collected for model update, a particular measured sample can be tested by comparing the output of the NN model for that sample and the expected output. If the output of the NN model for that sample and the expected output are within a threshold value, the sample may be indicated as not useful. If the output of the NN model for that sample and the expected output are not good match or the confidence of the output is low, the sample could be a sample with high importance. For example, if data is being collected for model monitoring, the importance of a particular measured sample can be evaluated using the confidence of the output model for that sample. In another example a model showing the complexity of the input data can be utilized, and more complex samples can have a higher importance. This information can be updated in a periodic, aperiodic, or event base manner which can assist the network/training node reflect the most recent statistics of the data which can enable a more accurate determination of the importance values.

Implementations described herein also provide solutions to determine which information to report. For instance, access to more information regarding collected data may assist in improving the performance of AI/ML models. For example, if the training node knows the condition under which different samples have been measured, it may be able to use that to train a separate model for different subgroup of dataset. To enable such implementations, an MDT framework can be enhanced to enable the UE report extra information along with the actual measured samples. Some messages/fields/parameters that can be used for this purpose include: A message configuring the UE which extra information to send along with the measured samples; a message to report the quality/confidence of the measured sample; a message to report how often such sample have been observed or the weight associated to that sample: a message to report network configuration. UE-side additional condition, or network-side additional condition under which different this sample (this group of samples) have been measured.

In implementations the UE can send a digest of collected samples, e.g., instead of sending the actual measurements. The digest can be one or more measured samples and/or samples that are generated based on the measured samples, but in some examples may be different than the measured samples. In one example instead of sending all collected samples, the samples can be partition into clusters and then for each cluster, the centroid can be sent and optionally the variance of the samples around the centroid. Further, a weight value associated with each sample can be utilized and the weight value can indicate how frequently this message may occur.

As another example the UE can construct a few representative samples such that using these samples for training of the model may approximate the impact of using all samples for training. For such implementations, the UE may utilize knowledge of a current state of the model to determine the suitable representative samples. Sending weight value(s) associated with each sample can be performed.

As another example, the UE can construct a generative model to generate samples such as the measured samples and alternatively or additionally to sending the samples, send the model. Alternatively or additionally the UE can send the input/parameters of a generative model that can be used to generate similar samples later. In examples such a model may be updated in a periodic, aperiodic, and/or event base manner. Such implementations can assist a UE in reflecting the most recent statistics of the data the UE has collected.

Some messages/fields/parameters that can be used for such purposes include: A message configuring a UE to report sample digests instead of at least a portion of measured samples: a message configuring the UE to know which scheme it should use to generate the sample digests: a message configuring the UE with a number of samples digest to be reported for each sample set with a particular number of samples which can be configured by the network: information regarding the model for which the data is collected for training/updating. The information can be in the form of a model with its parameters, its parameters only, or an ID using which the UE can determine/retrieve the model for example from another node: a message to report the sample digests instead of the measurements: a message to report the weight/importance of the digest sample.

Implementations also provide for configuring multiple logging configurations. A limitation of some MDT frameworks for AI/ML data collection is that some MDT frameworks support only one RAT-specific logged measurement configuration for logged MDT in the UE. For instance, when the network provides a new configuration, a previously configured logged measurement configuration can be entirely replaced by the new one. Moreover, logged measurements corresponding to the previous configuration can be cleared at the same time. For AI/ML, MDT frameworks can be extended to support a UE to have multiple logging configurations (e.g., for different (network) conditions) and also store multiple logged data. One possible solution can be to assign different logging IDs to different logging configuration. As another example, the UE can be configured to have a default logging/reporting configuration in addition to one or more logging/reporting configuration. Another extension can be that the network requests logged data for a specific network condition/configuration.

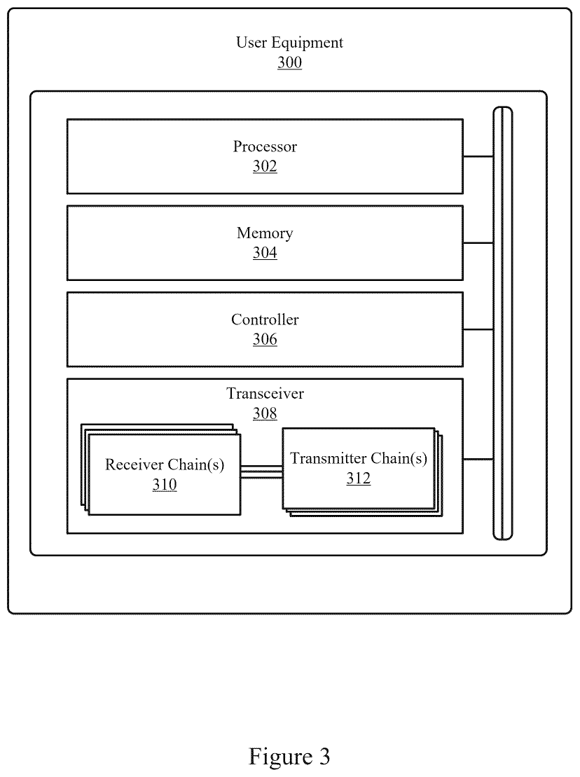

FIG. 3 illustrates an example of a UE 300 in accordance with aspects of the present disclosure. The UE 300 may include a processor 302, a memory 304, a controller 306, and a transceiver 308. The processor 302, the memory 304, the controller 306, or the transceiver 308, or various combinations thereof or various components thereof may be examples of means for performing various aspects of the present disclosure as described herein. These components may be coupled (e.g., operatively, communicatively, functionally, electronically, electrically) via one or more interfaces.

The processor 302, the memory 304, the controller 306, or the transceiver 308, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 302 may include an intelligent hardware device (e.g., a general-purpose processor, a DSP, a CPU, an ASIC, an FPGA, or any combination thereof). In some implementations, the processor 302 may be configured to operate the memory 304. In some other implementations, the memory 304 may be integrated into the processor 302. The processor 302 may be configured to execute computer-readable instructions stored in the memory 304 to cause the UE 300 to perform various functions of the present disclosure.

The memory 304 may include volatile or non-volatile memory. The memory 304 may store computer-readable, computer-executable code including instructions when executed by the processor 302 cause the UE 300 to perform various functions described herein. The code may be stored in a non-transitory computer-readable medium such as the memory 304 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 302 and the memory 304 coupled with the processor 302 may be configured to cause the UE 300 to perform one or more of the functions described herein (e.g., executing, by the processor 302, instructions stored in the memory 304). For example, the processor 302 may support wireless communication at the UE 300 in accordance with examples as disclosed herein. The UE 300 may be configured to or operable to support a means for receiving control information including a first field indicating a trigger event for a data collection process, wherein the trigger event is based at least in part on one or more of a data sample novelty measure, a change in a configuration parameter of a node, a change in a condition of a node, a model performance metric, or model monitoring output; triggering, based at least in part on an occurrence of the trigger event, a data collection process to generate a reporting set from a set of measured samples; and processing the reporting set based at least in part on the control information including to one or more of report the reporting set to a different node or log the reporting set to generate a logged reporting set.

Additionally, the UE 300 may be configured to support any one or combination of where the control information includes DCI; the different node includes one of a first network equipment from which the control information is received, or a second network equipment different than the first network equipment, and wherein the method further includes transmitting, based at least in part a request or a reporting event. A reporting event, for instance, can include an aggregation of a number of samples that exceeds a threshold, a request for a data sample report (e.g., from an NE), an expiry of a sample reporting timer, etc. Further, implementations can include transmitting the reporting set to one or more of the first network equipment or the second network equipment; the set of measured samples includes a set of channel data representations during a first time-frequency-space region; the control information includes one or more other fields including at least one of one or more purposes of the data collection process, an indication that the UE is to maintain the reporting set after reporting the reporting set, an indication specifying how to determine the data sample novelty measure for one or more data samples, a threshold number of data samples to be reported, a duration over which to report the reporting set, a duration over which to log the reporting set, or a set of additional information for determination of the data sample novelty measure; the set of additional information includes a set of parameters representing a model based on a neural network; the control information includes one or more other fields including one or more of values or conditions for UE configuration or UE conditions for which the UE is to monitor UE change, a duration over which to report the reporting set after the trigger event, a duration over which to log the reporting set after the trigger event, how many data samples to report as part of the reporting set, or how many data samples to log as part of the reporting set.

Additionally, the UE 300 may be configured to support any one or combination of where the control information includes one or more other fields including one or more of one or more purposes of the data collection process, a metric value to trigger the trigger event, a threshold value to trigger the trigger event, a duration over which to report the reporting set after the trigger event, a duration over which to log the reporting set after the trigger event, how many data samples to report as part of the reporting set, or how many data samples to log as part of the reporting set; the method further includes generating the reporting set based on a configuration including one or more fields including at least one of one or more purposes of the data collection process, an indication that the UE is to maintain the reporting set after reporting the reporting set, an indication specifying how to determine the data sample novelty measure for one or more data samples, a threshold number of data samples to be reported, a duration over which to report the reporting set, a duration over which to log the reporting set, or a set of additional information for determination of the data sample novelty measure; receiving the configuration as part of the control information; generating the reporting set including at least one of a subset of the set of measured samples or a sample subset generated based at least in part on a subset of the set of measured samples; the reporting set further includes at least one of one or more quality values for measurements used to generate the reporting set, one or more confidence values for measurements used to generate the reporting set, a rate of occurrence for one or more data samples of the reporting set, or one or more Conditions under which the measurements used to generate the reporting set were measured; the control information includes configuration information for multiple data collection processes.

Additionally, or alternatively, the UE 300 may support at least one memory (e.g., the memory 304) and at least one processor (e.g., the processor 302) coupled with the at least one memory and configured to cause the UE to receive control information including a first field indicating a trigger event for a data collection process, wherein the trigger event is based at least in part on one or more of a data sample novelty measure, a change in a configuration parameter of a node, a change in a condition of a node, a model performance metric, or model monitoring output; trigger, based at least in part on an occurrence of the trigger event, a data collection process to generate a reporting set from a set of measured samples; and process the reporting set based at least in part on the control information including to one or more of report the reporting set to a different node or log the reporting set to generate a logged reporting set.

Additionally, the UE 300 may be configured to support any one or combination of where the control information includes DCI; the different node includes one of a first network equipment from which the control information is received, or a second network equipment different than the first network equipment, and wherein the at least one processor is configured to cause the UE to transmit, based at least in part a request or a reporting event, the reporting set to one or more of the first network equipment or the second network equipment; the set of measured samples includes a set of channel data representations during a first time-frequency-space region; the control information includes one or more other fields including at least one of one or more purposes of the data collection process, an indication that the UE is to maintain the reporting set after reporting the reporting set, an indication specifying how to determine the data sample novelty measure for one or more data samples, a threshold number of data samples to be reported, a duration over which to report the reporting set, a duration over which to log the reporting set, or a set of additional information for determination of the data sample novelty measure; the set of additional information includes a set of parameters representing a model based on a neural network; the control information includes one or more other fields including one or more of values or conditions for UE configuration or UE conditions for which the UE is to monitor UE change, a duration over which to report the reporting set after the trigger event, a duration over which to log the reporting set after the trigger event, how many data samples to report as part of the reporting set, or how many data samples to log as part of the reporting set.

Additionally, the UE 300 may be configured to support any one or combination of where the control information includes one or more other fields including one or more of one or more purposes of the data collection process, a metric value to trigger the trigger event, a threshold value to trigger the trigger event, a duration over which to report the reporting set after the trigger event, a duration over which to log the reporting set after the trigger event, how many data samples to report as part of the reporting set, or how many data samples to log as part of the reporting set; the at least one processor is configured to cause the UE to generate the reporting set based on a configuration including one or more fields including at least one of one or more purposes of the data collection process, an indication that the UE is to maintain the reporting set after reporting the reporting set, an indication specifying how to determine the data sample novelty measure for one or more data samples, a threshold number of data samples to be reported, a duration over which to report the reporting set, a duration over which to log the reporting set, or a set of additional information for determination of the data sample novelty measure; the configuration is received as part of the control information; the at least one processor is configured to cause the UE to generate the reporting set including at least one of a subset of the set of measured samples or a sample subset generated based at least in part on a subset of the set of measured samples; the reporting set further includes at least one of one or more quality values for measurements used to generate the reporting set, one or more confidence values for measurements used to generate the reporting set, a rate of occurrence for one or more data samples of the reporting set, or one or more Conditions under which the measurements used to generate the reporting set were measured; the control information includes configuration information for multiple data collection processes.

The controller 306 may manage input and output signals for the UE 300. The controller 306 may also manage peripherals not integrated into the UE 300. In some implementations, the controller 306 may utilize an operating system such as iOS®, ANDROID®, WINDOWS®, or other operating systems. In some implementations, the controller 306 may be implemented as part of the processor 302.

In some implementations, the UE 300 may include at least one transceiver 308. In some other implementations, the UE 300 may have more than one transceiver 308. The transceiver 308 may represent a wireless transceiver. The transceiver 308 may include one or more receiver chains 310, one or more transmitter chains 312, or a combination thereof.

A receiver chain 310 may be configured to receive signals (e.g., control information, data, packets) over a wireless medium. For example, the receiver chain 310 may include one or more antennas to receive a signal over the air or wireless medium. The receiver chain 310 may include at least one amplifier (e.g., a low-noise amplifier (LNA)) configured to amplify the received signal. The receiver chain 310 may include at least one demodulator configured to demodulate the receive signal and obtain the transmitted data by reversing the modulation technique applied during transmission of the signal. The receiver chain 310 may include at least one decoder for decoding the demodulated signal to receive the transmitted data.

A transmitter chain 312 may be configured to generate and transmit signals (e.g., control information, data, packets). The transmitter chain 312 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 312 may also include at least one power amplifier configured to amplify the modulated signal to an appropriate power level suitable for transmission over the wireless medium. The transmitter chain 312 may also include one or more antennas for transmitting the amplified signal into the air or wireless medium.

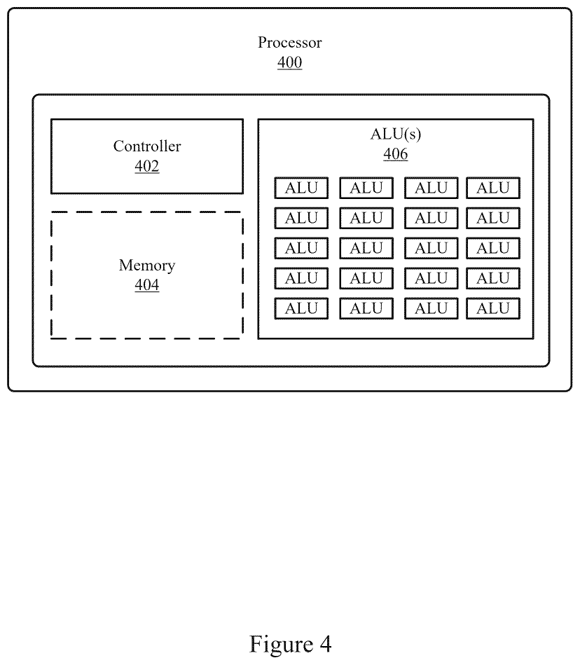

FIG. 4 illustrates an example of a processor 400 in accordance with aspects of the present disclosure. The processor 400 may be an example of a processor configured to perform various operations in accordance with examples as described herein. The processor 400 may include a controller 402 configured to perform various operations in accordance with examples as described herein. The processor 400 may optionally include at least one memory 404, which may be, for example, an L1/L2/L3 cache. Additionally, or alternatively, the processor 400 may optionally include one or more arithmetic-logic units (ALUs) 406. One or more of these components may be in electronic communication or otherwise coupled (e.g., operatively, communicatively, functionally, electronically, electrically) via one or more interfaces (e.g., buses).

The processor 400 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 400) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 402 may be configured to manage and coordinate various operations (e.g., signaling, receiving, obtaining, retrieving, transmitting, outputting, forwarding, storing, determining, identifying, accessing, writing, reading) of the processor 400 to cause the processor 400 to support various operations in accordance with examples as described herein. For example, the controller 402 may operate as a control unit of the processor 400, generating control signals that manage the operation of various components of the processor 400. These control signals include enabling or disabling functional units, selecting data paths, initiating memory access, and coordinating timing of operations.

The controller 402 may be configured to fetch (e.g., obtain, retrieve, receive) instructions from the memory 404 and determine subsequent instruction(s) to be executed to cause the processor 400 to support various operations in accordance with examples as described herein. The controller 402 may be configured to track memory addresses of instructions associated with the memory 404. The controller 402 may be configured to decode instructions to determine the operation to be performed and the operands involved. For example, the controller 402 may be configured to interpret the instruction and determine control signals to be output to other components of the processor 400 to cause the processor 400 to support various operations in accordance with examples as described herein. Additionally, or alternatively, the controller 402 may be configured to manage flow of data within the processor 400. The controller 402 may be configured to control transfer of data between registers, ALUs 406, and other functional units of the processor 400.

The memory 404 may include one or more caches (e.g., memory local to or included in the processor 400 or other memory, such as RAM, ROM, DRAM, SDRAM, SRAM, MRAM, flash memory, etc. In some implementations, the memory 404 may reside within or on a processor chipset (e.g., local to the processor 400). In some other implementations, the memory 404 may reside external to the processor chipset (e.g., remote to the processor 400).

The memory 404 may store computer-readable, computer-executable code including instructions that, when executed by the processor 400, cause the processor 400 to perform various functions described herein. The code may be stored in a non-transitory computer-readable medium such as system memory or another type of memory. The controller 402 and/or the processor 400 may be configured to execute computer-readable instructions stored in the memory 404 to cause the processor 400 to perform various functions. For example, the processor 400 and/or the controller 402 may be coupled with or to the memory 404, the processor 400, and the controller 402, and may be configured to perform various functions described herein. In some examples, the processor 400 may include multiple processors and the memory 404 may include multiple memories. One or more of the multiple processors may be coupled with one or more of the multiple memories, which may, individually or collectively, be configured to perform various functions herein.

The one or more ALUs 406 may be configured to support various operations in accordance with examples as described herein. In some implementations, the one or more ALUs 406 may reside within or on a processor chipset (e.g., the processor 400). In some other implementations, the one or more ALUs 406 may reside external to the processor chipset (e.g., the processor 400). One or more ALUs 406 may perform one or more computations such as addition, subtraction, multiplication, and division on data. For example, one or more ALUs 406 may receive input operands and an operation code, which determines an operation to be executed. One or more ALUs 406 may be configured with a variety of logical and arithmetic circuits, including adders, subtractors, shifters, and logic gates, to process and manipulate the data according to the operation. Additionally, or alternatively, the one or more ALUs 406 may support logical operations such as AND, OR, exclusive-OR (XOR), not-OR (NOR), and not-AND (NAND), enabling the one or more ALUs 406 to handle conditional operations, comparisons, and bitwise operations.

The processor 400 may support wireless communication in accordance with examples as disclosed herein. The processor 400 may be configured to or operable to support at least one controller (e.g., the controller 402) coupled with at least one memory (e.g., the memory 404) and configured to cause the processor to receive control information including a first field indicating a trigger event for a data collection process, wherein the trigger event is based at least in part on one or more of a data sample novelty measure, a change in a configuration parameter of a node, a change in a condition of a node, a model performance metric, or model monitoring output; trigger, based at least in part on an occurrence of the trigger event, a data collection process at a UE to generate a reporting set from a set of measured samples; and process the reporting set based at least in part on the control information including to one or more of report the reporting set to a different node or log the reporting set to generate a logged reporting set.

Additionally, the processor 400 may be configured to or operable to support any one or combination of where the control information includes DCI; the different node includes one of a first network equipment from which the control information is received, or a second network equipment different than the first network equipment, and wherein the at least one controller is configured to cause the processor to transmit, based at least in part a request or a reporting event, the reporting set to one or more of the first network equipment or the second network equipment; the set of measured samples includes a set of channel data representations during a first time-frequency-space region; the control information includes one or more other fields including at least one of one or more purposes of the data collection process, an indication that the UE is to maintain the reporting set after reporting the reporting set, an indication specifying how to determine the data sample novelty measure for one or more data samples, a threshold number of data samples to be reported, a duration over which to report the reporting set, a duration over which to log the reporting set, or a set of additional information for determination of the data sample novelty measure; the set of additional information includes a set of parameters representing a model based on a neural network; the control information includes one or more other fields including one or more of values or conditions for UE configuration or UE conditions for which the UE is to monitor UE change, a duration over which to report the reporting set after the trigger event, a duration over which to log the reporting set after the trigger event, how many data samples to report as part of the reporting set, or how many data samples to log as part of the reporting set.

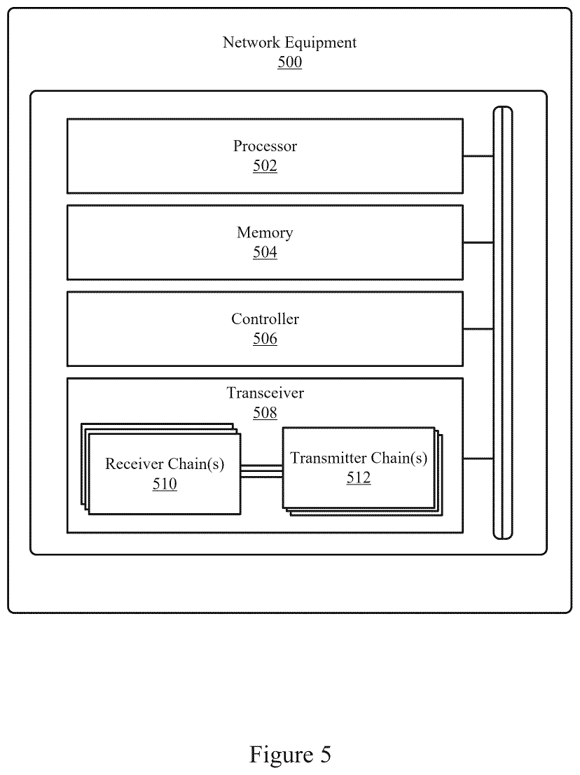

FIG. 5 illustrates an example of a NE 500 in accordance with aspects of the present disclosure. The NE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the NE 500 to perform various functions of the present disclosure.

The memory 504 may include volatile or non-volatile memory. The memory 504 may store computer-readable, computer-executable code including instructions when executed by the processor 502 cause the NE 500 to perform various functions described herein. The code may be stored in a non-transitory computer-readable medium such as the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the NE 500 to perform one or more of the functions described herein (e.g., executing, by the processor 502, instructions stored in the memory 504). For example, the processor 502 may support wireless communication at the NE 500 in accordance with examples as disclosed herein. The NE 500 may be configured to or operable to support a means for transmitting, to a UE, control information including a first field indicating a trigger event for a data collection process, wherein the trigger event is based at least in part on one or more of a data sample novelty measure, a change in a configuration parameter of a node, a change in a condition of a node, a model performance metric, or model monitoring output; and receiving a report including a reporting set of data samples generated based at least in part on the control information.

Additionally, the NE 500 may be configured to or operable to support any one or combination of transmitting the control information via DCI; the control information includes one or more other fields including at least one of one or more purposes of the data collection process, an indication that the UE is to maintain the reporting set after reporting the reporting set, an indication specifying how to determine the data sample novelty measure for one or more data samples, a threshold number of data samples to be reported, a duration over which to report the reporting set, a duration over which to log the reporting set, or a set of additional information for determination of the data sample novelty measure; the set of additional information includes a set of parameters representing a model based on a neural network; the control information includes one or more other fields including one or more of values or conditions for UE configuration or UE conditions for which the UE is to monitor UE change, a duration over which to report the reporting set after the trigger event, a duration over which to log the reporting set after the trigger event, how many data samples to report as part of the reporting set, or how many data samples to log as part of the reporting set.

Additionally, or alternatively, the NE 500 may support at least one memory (e.g., the memory 504) and at least one processor (e.g., the processor 502) coupled with the at least one memory and configured to cause the NE to transmit, to a UE, control information including a first field indicating a trigger event for a data collection process, wherein the trigger event is based at least in part on one or more of a data sample novelty measure, a change in a configuration parameter of a node, a change in a condition of a node, a model performance metric, or model monitoring output; and receive a report including a reporting set of data samples generated based at least in part on the control information.

Additionally, the NE 500 may be configured to support any one or combination of where the at least one processor is configured to cause the network equipment to transmit the control information via DCI; the control information includes one or more other fields including at least one of one or more purposes of the data collection process, an indication that the UE is to maintain the reporting set after reporting the reporting set, an indication specifying how to determine the data sample novelty measure for one or more data samples, a threshold number of data samples to be reported, a duration over which to report the reporting set, a duration over which to log the reporting set, or a set of additional information for determination of the data sample novelty measure; the set of additional information includes a set of parameters representing a model based on a neural network; the control information includes one or more other fields including one or more of values or conditions for UE configuration or UE conditions for which the UE is to monitor UE change, a duration over which to report the reporting set after the trigger event, a duration over which to log the reporting set after the trigger event, how many data samples to report as part of the reporting set, or how many data samples to log as part of the reporting set.

The controller 506 may manage input and output signals for the NE 500. The controller 506 may also manage peripherals not integrated into the NE 500. In some implementations, the controller 506 may utilize an operating system such as iOS®, ANDROID®, WINDOWS®, or other operating systems. In some implementations, the controller 506 may be implemented as part of the processor 502.

In some implementations, the NE 500 may include at least one transceiver 508. In some other implementations, the NE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas to receive a signal over the air or wireless medium. The receiver chain 510 may include at least one amplifier (e.g., a low-noise amplifier (LNA)) configured to amplify the received signal. The receiver chain 510 may include at least one demodulator configured to demodulate the receive signal and obtain the transmitted data by reversing the modulation technique applied during transmission of the signal. The receiver chain 510 may include at least one decoder for decoding the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

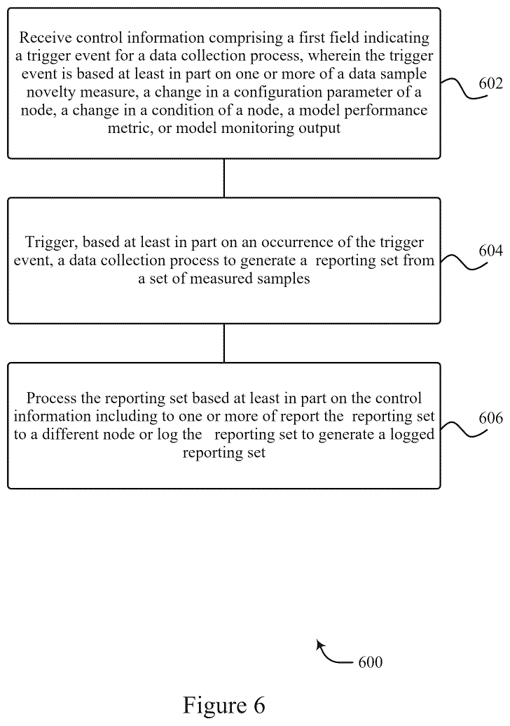

FIG. 6 illustrates a flowchart of a method 600 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 602, the method may include receiving control information comprising a first field indicating a trigger event for a data collection process, wherein the trigger event is based at least in part on one or more of a data sample novelty measure, a change in a configuration parameter of a node, a change in a condition of a node, a model performance metric, or model monitoring output. The operations of 602 may be performed in accordance with examples as described herein. In some implementations, aspects of the operations of 602 may be performed by a UE as described with reference to FIG. 3.

At 604, the method may include triggering, based at least in part on an occurrence of the trigger event, a data collection process to generate a reporting set from a set of measured samples. The operations of 604 may be performed in accordance with examples as described herein. In some implementations, aspects of the operations of 604 may be performed by a UE as described with reference to FIG. 3.

At 606, the method may include processing the reporting set based at least in part on the control information including to one or more of report the reporting set to a different node or log the reporting set to generate a logged reporting set. The operations of 606 may be performed in accordance with examples as described herein. In some implementations, aspects of the operations of 606 may be performed a UE as described with reference to FIG. 3.

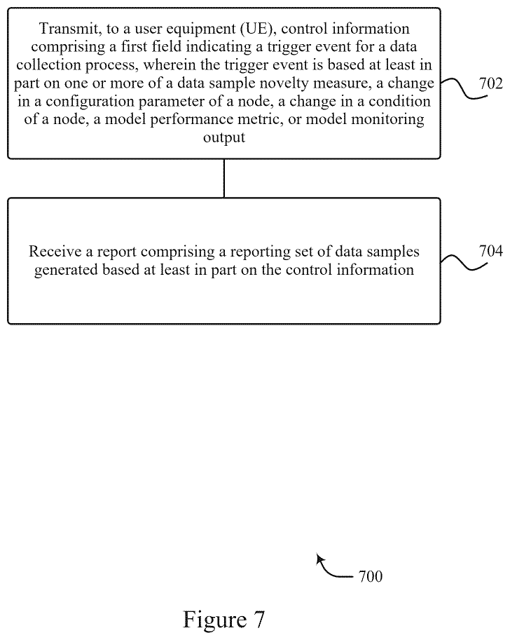

FIG. 7 illustrates a flowchart of a method 700 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 702, the method may include transmitting, to a UE, control information comprising a first field indicating a trigger event for a data collection process, wherein the trigger event is based at least in part on one or more of a data sample novelty measure, a change in a configuration parameter of a node, a change in a condition of a node, a model performance metric, or model monitoring output. The operations of 702 may be performed in accordance with examples as described herein. In some implementations, aspects of the operations of 702 may be performed by a NE as described with reference to FIG. 5.

At 704, the method may include receiving a report comprising a reporting set of data samples generated based at least in part on the control information. The operations of 704 may be performed in accordance with examples as described herein. In some implementations, aspects of the operations of 704 may be performed by a NE as described with reference to FIG. 5.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive control information comprising a first field indicating a trigger event for a data collection process, wherein the trigger event is based at least in part on one or more of a data sample novelty measure, a change in a configuration parameter of a node, a change in a condition of a node, a model performance metric, or model monitoring output;
trigger, based at least in part on an occurrence of the trigger event, a data collection process to generate a reporting set from a set of measured samples; and
process the reporting set based at least in part on the control information including to one or more of report the reporting set to a different node or log the reporting set to generate a logged reporting set.

2. The UE of claim 1, wherein the control information comprises downlink control information (DCI).

3. The UE of claim 1, wherein the different node comprises one of a first network equipment from which the control information is received, or a second network equipment different than the first network equipment, and wherein the at least one processor is configured to cause the UE to transmit, based at least in part a request or a reporting event, the reporting set to one or more of the first network equipment or the second network equipment.

4. The UE of claim 1, wherein the set of measured samples comprises a set of channel data representations during a first time-frequency-space region.

5. The UE of claim 1, wherein the control information comprises one or more other fields comprising at least one of one or more purposes of the data collection process, an indication that the UE is to maintain the reporting set after reporting the reporting set, an indication specifying how to determine the data sample novelty measure for one or more data samples, a threshold number of data samples to be reported, a duration over which to report the reporting set, a duration over which to log the reporting set, or a set of additional information for determination of the data sample novelty measure.

6. The UE of claim 5, wherein the set of additional information comprises a set of parameters representing a model based on a neural network.

7. The UE of claim 1, wherein the control information comprises one or more other fields comprising one or more of values or conditions for UE configuration or UE conditions for which the UE is to monitor UE change, a duration over which to report the reporting set after the trigger event, a duration over which to log the reporting set after the trigger event, how many data samples to report as part of the reporting set, or how many data samples to log as part of the reporting set.

8. The UE of claim 1, wherein the control information comprises one or more other fields comprising one or more of one or more purposes of the data collection process, a metric value to trigger the trigger event, a threshold value to trigger the trigger event, a duration over which to report the reporting set after the trigger event, a duration over which to log the reporting set after the trigger event, how many data samples to report as part of the reporting set, or how many data samples to log as part of the reporting set.

9. The UE of claim 1, wherein the at least one processor is configured to cause the UE to generate the reporting set based on a configuration comprising one or more fields comprising at least one of one or more purposes of the data collection process, an indication that the UE is to maintain the reporting set after reporting the reporting set, an indication specifying how to determine the data sample novelty measure for one or more data samples, a threshold number of data samples to be reported, a duration over which to report the reporting set, a duration over which to log the reporting set, or a set of additional information for determination of the data sample novelty measure.

10. The UE of claim 9, wherein the configuration is received as part of the control information.

11. The UE of claim 1, wherein the at least one processor is configured to cause the UE to generate the reporting set comprising at least one of a subset of the set of measured samples or a sample subset generated based at least in part on a subset of the set of measured samples.

12. The UE of claim 11, wherein the reporting set further comprises at least one of one or more quality values for measurements used to generate the reporting set, one or more confidence values for measurements used to generate the reporting set, a rate of occurrence for one or more data samples of the reporting set, or one or more Conditions under which the measurements used to generate the reporting set were measured.

13. The UE of claim 1, wherein the control information comprises configuration information for multiple data collection processes.

14. A processor for wireless communication, comprising:
at least one controller coupled with at least one memory and configured to cause the processor to:
receive control information comprising a first field indicating a trigger event for a data collection process, wherein the trigger event is based at least in part on one or more of a data sample novelty measure, a change in a configuration parameter of a node, a change in a condition of a node, a model performance metric, or model monitoring output;
trigger, based at least in part on an occurrence of the trigger event, a data collection process to generate a reporting set from a set of measured samples; and
process the reporting set based at least in part on the control information including to one or more of report the reporting set to a different node or log the reporting set to generate a logged reporting set.

15. A network equipment for wireless communication, comprising:
at least one memory; and
at least one processor coupled with the at least one memory and configured to cause the network equipment to:
transmit, to a user equipment (UE), control information comprising a first field indicating a trigger event for a data collection process, wherein the trigger event is based at least in part on one or more of a data sample novelty measure, a change in a configuration parameter of a node, a change in a condition of a node, a model performance metric, or model monitoring output; and
receive a report comprising a reporting set of data samples generated based at least in part on the control information.

16. The network equipment of claim 15, wherein the at least one processor is configured to cause the network equipment to transmit the control information via downlink control information (DCI).

17. The network equipment of claim 15, wherein the control information comprises one or more other fields comprising at least one of one or more purposes of the data collection process, an indication that the UE is to maintain the reporting set after reporting the reporting set, an indication specifying how to determine the data sample novelty measure for one or more data samples, a threshold number of data samples to be reported, a duration over which to report the reporting set, a duration over which to log the reporting set, or a set of additional information for determination of the data sample novelty measure.

18. The network equipment of claim 17, wherein the set of additional information comprises a set of parameters representing a model based on a neural network.

19. The network equipment of claim 15, wherein the control information comprises one or more other fields comprising one or more of values or conditions for UE configuration or UE conditions for which the UE is to monitor UE change, a duration over which to report the reporting set after the trigger event, a duration over which to log the reporting set after the trigger event, how many data samples to report as part of the reporting set, or how many data samples to log as part of the reporting set.

20. A method performed by a user equipment (UE), the method comprising:
receiving control information comprising a first field indicating a trigger event for a data collection process, wherein the trigger event is based at least in part on one or more of a data sample novelty measure, a change in a configuration parameter of a node, a change in a condition of a node, a model performance metric, or model monitoring output;
triggering, based at least in part on an occurrence of the trigger event, a data collection process to generate a reporting set from a set of measured samples; and
processing the reporting set based at least in part on the control information including to one or more of report the reporting set to a different node or log the reporting set to generate a logged reporting set.
